(19) United States
(12) Patent Application Publication
(10) Pub. No.: US 2026/0256141 A1
(43) Pub. Date: Sep. 3, 2026

(54) INSECTICIDAL COMPOSITION AND PROCESS FOR PREPARATION THEREOF

(71) Applicants: UPL MAURITIUS LIMITED, Port Louis (MU); UPL EUROPE SUPPLY CHAIN GMBH, Rotkreuz/Risch (CH)

(72) Inventors: Charles Flood, Evesham (GB); Pedro Ventura, Evesham (GB)

(73) Assignees: UPL MAURITIUS LIMITED, Port Louis (MU); UPL EUROPE SUPPLY CHAIN GMBH, Rotkreuz/Risch (CH)

(21) Appl. No.: 19/159,911

(22) PCT Filed: Mar. 1, 2024
(86) PCT No.: PCT/EP2024/055411

§ 371 Date: Aug. 26, 2025

(30) Foreign Application Priority Data
Mar. 1, 2023 (GB) 2303005.9

(51) Int. Cl. A01N 43/38; A01N 25/04; A01N 25/30; A01P 7/04

(52) U.S. Cl. CPC A01N 43/38; A01N 25/04; A01N 25/30; A01P 7/04

(57) ABSTRACT

The present invention relates to a liquid insecticidal composition comprising at least one tetramic acid derivative and one or more inactive ingredients. Particularly, the present invention relates to a suspension concentrate comprising spirotetramat. The present invention also relates to a process for preparing said composition.

### FIELD OF INVENTION

The present invention relates to a liquid insecticidal composition comprising at least one tetramic acid derivative and one or more inactive ingredients. Particularly, the present invention relates to a suspension concentrate comprising spirotetramat. The present invention also relates to a process for preparing said composition.

### BACKGROUND OF THE INVENTION

Methods of controlling or eradicating insect pests are desirable in many instances, more so when crops are of commercial interest. Insects are destructive to the crop and can cause significant damage and loss of yield. There are more than ten thousand species of pests that cause losses in agriculture. Insecticides majorly work via two modes of action viz. systemic and contact insecticidal activity. While systemic insecticides are absorbed and distributed systemically throughout plants and kill pests that ingest the insecticide while feeding, contact insecticides kill when they are in contact with pests and are absorbed through their bodies. Tetramic acid derivatives are systemic insecticides that ensure high efficacy against sucking pests (aphids, white flies) at low dose rates for foliar and soil uses and have residual or long-term activity.

Tetramic acid derivatives are commonly formulated as liquid compositions. However, the first challenge in developing stable liquid compositions is maintaining physio-chemical stability of the composition for long durations of storage and using active components such as tetramic acid insecticides which are insoluble. Compositions exhibit instability owing to the selection of unsuitable and incompatible adjuvants/excipients. Secondly, since tetramic acid insecticides are systemic insecticides that need to be absorbed throughout the plant, compositions containing said insecticides might require suitable adjuvants that aid in such absorption. Thus, there remains a need to develop a liquid insecticidal composition comprising tetramic acid derivatives, which is stable over long periods of time, does not deteriorate under severe storage conditions and is less phytotoxic to plants.

Amongst insecticides, tetramic acid derivatives such as spirotetramat have gained wide-spread acceptance due to their ability to demonstrate efficacy against a broad spectrum of sucking insects and defending a wide range of crops. Specifically, they work by inhibiting lipogenesis in insects, the result of which is decreased lipid content, growth inhibition in younger insects, and impairment in reproduction.

Spirotetramat (IUPAC name: cis-3-(2,5-dimethylphenyl)-8-methoxy-2-oxo-1-azaspiro[4.5]dec-3-en-4-yl ethyl carbonate) is a tetramic acid derivative. Spirotetramat exhibits dual activity by allowing translocation in xylem vessels and phloem sieve elements, thus offering shoot to root protection. It acts as an inhibitor of lipid biosynthesis and affects juvenile stages with additional effects on adult fecundity. The efficacy of spirotetramat on adult insects is reduced due to their mobility; they tend to produce nymphs that die within 24 hours, or the nymphs are non-fertile, thus reducing procreation and fertility of future generations. Considering the bio-efficacy of spirotetramat there is a compelling need to prepare a formulation having high strength of the said active with stable physico-chemical properties.

Many pesticidal compositions have been developed over time to destroy pests and alleviate the damages they cause. These compositions are often applied to the environment in which the insects or other pests live or where their eggs are present, including the air surrounding them, the food they eat, or objects which they contact. Several of these compositions are vulnerable to chemical and physical degradation when applied to these environments. If degradation occurs, the activity of the pesticides can be adversely affected and eventually the compositions are rendered unstable.

There is also a need for preparing highly concentrated or high strength formulations comprising agrochemical actives because of the advantages attributed to such formulations. With highly concentrated formulations, a lower packaging effort is required than with low-concentration formulations. The effort for production, transport (quantity and frequency) and for storage is considerably reduced. Providing such a formulation will indirectly have a positive effect on the environment and on economic returns.

Suspension concentrate (SC) formulations are a solid active ingredient dispersed in water. SC's have grown in popularity due to benefits such as absence of dust, ease of use and effectiveness when compared to formulation types such as emulsifiable concentrates (EC) and wettable powder (WP) formulations. To formulate a stable SC, the active ingredient must remain insoluble under all temperature conditions. The use of polymeric dispersants in high loaded suspension concentrate formulations is recommended due to their higher molecular weight, large repulsive barrier and many anchoring groups per molecule, thus enabling the formulation of high loaded, stable suspension concentrates. Prior art literature has not provided an optimal dispersant system to arrive at a stable, high strength, suspension concentrate comprising a tetramic acid derivative.

Thus, there has been an ongoing need to develop a stable formulation containing spirotetramat, which has good shelf life and storage stability, and which is capable of being diluted at the time of on field application as per requirements.

### SUMMARY OF THE INVENTION

In an aspect, the present invention provides a liquid agrochemical composition comprising at least one tetramic acid derivative, one or more dispersing agents selected from a non-ionic copolymer and an anionic dispersant and one or more agriculturally acceptable excipients.

In an aspect, the present invention provides a liquid insecticidal composition comprising a tetramic acid derivative and one or more dispersing agents comprising a non-ionic copolymer and an anionic dispersant, and agrochemically acceptable excipients, wherein the non-ionic copolymer and the anionic dispersant is in a ratio ranging from 1:15 to 15:1.

In another aspect, the present invention provides a liquid insecticidal composition comprising spirotetramat and one or more dispersing agents comprising a non-ionic copolymer dispersant and agrochemically acceptable excipients, wherein the non-ionic copolymer and the anionic dispersant is in a ratio ranging from 1:15 to 15:1.

In another aspect, the present invention provides a liquid insecticidal composition comprising spirotetramat and one or more dispersing agents comprising a non-ionic copolymer and an anionic dispersant and agrochemically acceptable excipients, wherein the non-ionic copolymer and the anionic dispersant is in a ratio ranging from 1:10 to 10:1.

In another aspect, the present invention provides a liquid insecticidal composition comprising spirotetramat and one or more dispersing agents comprising a non-ionic copolymer and an anionic dispersant and agrochemically acceptable excipients, wherein the non-ionic copolymer and the anionic dispersant is in a ratio ranging from 1:5 to 5:1.

In another aspect, the present invention provides a liquid insecticidal composition comprising spirotetramat and one or more dispersing agents comprising a non-ionic copolymer and an anionic dispersant and agrochemically acceptable excipients, wherein the non-ionic copolymer and the anionic dispersant is in a ratio ranging from 1:2 to 2:1.

In an aspect, the liquid insecticidal composition is a suspension concentrate (SC).

In an aspect, the present invention provides a suspension concentrate comprising;
(a) ≥300 g/L of a tetramic acid derivative insecticide,
(b) one or more dispersing agents comprising a non-ionic copolymer and an anionic dispersant, and
(c) agriculturally acceptable excipients,
   wherein the non-ionic copolymer and the anionic dispersant is in a ratio ranging from 1:15 to 15:1.

In an aspect, the present invention provides a suspension concentrate comprising;
(a) ≥300 g/L of a tetramic acid derivative insecticide,
(b) one or more dispersing agents comprising a non-ionic copolymer and an anionic dispersant, and
(c) agriculturally acceptable excipients,
   wherein the non-ionic copolymer and the anionic dispersant is in a ratio ranging from 1:10 to 10:1.

In another aspect, the present invention provides a suspension concentrate comprising;
(a) ≥300 g/L of a tetramic acid derivative insecticide,
(b) one or more dispersing agents comprising a non-ionic copolymer and an anionic dispersant, and
(c) agriculturally acceptable excipients,
   wherein the non-ionic copolymer and the anionic dispersant is in a ratio ranging from 1:5 to 5:1.

In another aspect, the present invention provides a suspension concentrate comprising;
(a) ≥300 g/L of a tetramic acid derivative insecticide,
(b) one or more dispersing agents comprising a non-ionic copolymer and an anionic dispersant, and
(c) agriculturally acceptable excipients,
   wherein the non-ionic copolymer and the anionic dispersant is in a ratio ranging from 1:2 to 2:1.

In yet another aspect, the present invention provides a suspension concentrate comprising a tetramic acid derivative insecticide in a concentration ranging from 300 g/L to 600 g/L.

In an aspect, the present invention provides a suspension concentrate comprising;
(a) ≥300 g/L of spirotetramat,
(b) polymethyl methacrylate-polyethylene glycol graft copolymer,
(c) sodium salt of naphthalene sulfonate condensate,
(d) agriculturally acceptable excipients,
wherein the polymethyl methacrylate-polyethylene glycol graft copolymer and the sodium salt of naphthalene sulfonate condensate is in a ratio ranging from 1:10 to 10:1.

In an aspect, the present invention provides a suspension concentrate comprising;
(a) ≥300 g/L of spirotetramat,
(b) polymethyl methacrylate-polyethylene glycol graft copolymer,
(c) sodium salt of naphthalene sulfonate condensate,
(d) agriculturally acceptable excipients,
wherein the polymethyl methacrylate-polyethylene glycol graft copolymer and the sodium salt of naphthalene sulfonate condensate is in a ratio ranging from 1:5 to 5:1.

In an aspect, the present invention provides a suspension concentrate comprising;
(a) ≥300 g/L of spirotetramat,
(b) polymethyl methacrylate-polyethylene glycol graft copolymer,
(c) sodium salt of naphthalene sulfonate condensate,
(d) agriculturally acceptable excipients,
wherein the polymethyl methacrylate-polyethylene glycol graft copolymer and the sodium salt of naphthalene sulfonate condensate is in a ratio ranging from 1:2 to 2:1.

In yet another aspect, the present invention provides a suspension concentrate comprising spirotetramat in a concentration ranging from 300 g/L to 600 g/L.

In yet another aspect, the present invention provides a suspension concentrate comprising spirotetramat in a concentration of 360 g/L.

In yet another aspect, the present invention provides a suspension concentrate comprising spirotetramat in a concentration ranging from 30% w/v to 60% w/v.

In yet another aspect, the present invention provides a suspension concentrate comprising spirotetramat in a concentration of 36% w/v.

In another aspect, the present invention provides a process of preparing an insecticidal suspension concentrate.

In yet another aspect, the present invention provides use of the present composition comprising at least one tetramic acid derivative insecticide and one or more dispersing agents selected from a non-ionic copolymer and an anionic dispersant, for controlling pests particularly insects.

In one aspect, the present invention provides a method of controlling insect pest, the method comprising applying to a plant or a plant part or a plant propagation material an insecticidally effective amount of a suspension concentrate comprising at least one tetramic acid derivative insecticide and one or more dispersing agents selected from a non-ionic copolymer and an anionic dispersant.

### DETAILED DESCRIPTION OF THE INVENTION

The following description is provided to assist in a comprehensive understanding of exemplary embodiments of the invention. It includes various specific details to assist in that understanding but these are to be regarded as merely exemplary.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for limiting the scope of the invention.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments.

As used herein, the terms “comprises,” “comprising,” “includes,” “including,” “has,” “having,” “contains”, “containing,” “characterized by” or any other variation thereof, are intended to cover a nonexclusive inclusion, subject to any limitation explicitly indicated. For example, a composition, mixture, process, or method that comprises a list of elements is not necessarily limited to only those elements but may include other elements not expressly listed or inherent to such composition, mixture, process, or method.

In any aspect or embodiment described hereinbelow, the phrase comprising may be replaced by the phrases “consisting of” or “consisting essentially of”.

In these aspects or embodiments, the combinations or compositions described includes or comprises or consists of or consists essentially of or consists substantially of the specific components recited therein, to the exclusion of other ingredients or excipients not specifically recited therein.

The term “insects” includes all organisms in the class “Insecta”.

The term “Insecticidal” refers to the ability of a substance to increase mortality or inhibit, growth rate of insects. Insecticide refers to the ability of a substance to increase mortality or inhibit, growth rate of insects. The term resistance may be partial or complete and it will be appreciated that all degrees of resistance are included in the meaning of this term, whether they be very low resistance, low resistance, high resistance, very high resistance or total resistance.

The term ‘insecticidally effective amount of the insecticide’ refers to an amount of the insecticide that kills or inhibits the phytopathogenic disease for which control is desired, in an amount not significantly toxic to the crop being treated.

The term “locus” as used herein refers to a place to which a composition according to the invention is applied. It includes application to an individual plant, a group of plants such as a plant and/or its surrounding, and the region in which plants may be planted as well as application directly to an insect or insects and/or the vicinity in which they are located.

The term ‘plants’ refers to all physical parts of a plant, including seeds, seedlings, saplings, roots, tubers, stems, stalks, foliage, and fruits.

The term “crop” refers both to growing and harvested crops. The term “agriculturally acceptable amount of active refers to an amount of an active that controls or inhibits the pest on which control is desired, in an amount not significantly toxic to the plant being treated.

The term “contacting” used herein includes both direct contact (applying the compositions directly on the pest or plant typically to the foliage, stem, or roots of the plant) and indirect contact (applying the compositions to the locus of the pest or plant).

To “control” or “controlling” insects means to inhibit, through a toxic effect, the ability of insect pests to survive, grow, feed, and/or reproduce, or to limit insect-related damage or loss in crop plants.

To “control” insects may or may not mean killing the insects, although it preferably means reducing insect population by killing the insects. The common names of active ingredients as mentioned in this specification are known from the “handbook of insecticides” 13th edition, British crop protection commission (2003) and are also available at link https://www.alanwood.net/pesticides.

The term ‘stable’ referred to herein refers to chemical and/or physical stabilization of the active ingredients in the composition and desired suspensibility and dispersibility of the composition by maintaining homogeneity of the components that impart longer shelf life.

The terms “ambient temperature” and “room temperature” as utilized herein shall generally mean any suitable temperature found in a laboratory or other working quarter, and is generally not below about 15° C. nor above about 30° C.

The physicochemical studies of the compositions/formulation is performed according to the CIPAC standard method.

References to the sign ‘≥’ signifies greater than equal to the numerical value.

The term AHS refer to Accelerated heat stability (AHS), wherein experimental studies are carried out to determine the stability of the composition after 14 days of preparing the said composition at a temperature of 54° C. In an aspect, the present invention provides a stable liquid composition that is stable over long periods of time and does not deteriorate under severe storage conditions.

The term ‘high load’ or ‘high strength’ formulation refers to a high concentration of a solute, i.e. the active ingredient in a solvent i.e, moles of solute per litre of solution.

The present inventors have provided a highly concentrated liquid insecticidal formulation comprising a tetramic acid derivative, which is stable for prolonged periods and under extreme conditions. The present inventors have provided an optimal dispersant system to arrive at a stable, high strength, suspension concentrate comprising a tetramic acid derivative. The effort for production, transport and for storage is considerably reduced in preparing such insecticidal formulations. Having a high strength spirotetramat formulation requires lower packaging effort compared to low-concentration formulations. The present inventors have provided a dispersant system comprising a non-ionic copolymer and an anionic dispersant to provide a stable suspension concentrate.

In an embodiment, the present invention provides a liquid insecticidal composition comprising at least one tetramic acid derivative insecticide and one or more dispersing agents comprising a non-ionic copolymer and an anionic dispersant.

In an embodiment, the tetramic acid derivative insecticide is selected from the group comprising spirotetramat, spidoxamat and spiropidion.

In a preferred embodiment, the tetramic acid derivative is spirotetramat.

In an embodiment, the non-ionic copolymer comprises an alkyl based methacrylate-polyethylene glycol graft copolymer,

In an embodiment, the non-ionic copolymer comprises a methyl methacrylate-polyethylene glycol graft copolymer or a polymethyl methacrylate-polyethylene glycol graft copolymer.

In an embodiment, the non-ionic copolymer comprises a polymethyl methacrylate-polyethylene glycol graft copolymer.

In an embodiment, the anionic dispersant comprises a sulfonate condensate.

In an embodiment, the anionic dispersant comprises an alkali salt of naphthalene sulfonate condensate.

In an embodiment, the anionic dispersant comprises sodium naphthalene sulfonate condensate.

In an embodiment the non-ionic copolymers and the anionic dispersant are present in a ratio ranging from 1:15 to 15:1.

In another embodiment, the non-ionic copolymer and the anionic dispersant are present in a ratio ranging from 1:10 to 10:1.

In another embodiment, the non-ionic copolymer and the anionic dispersant are present in a ratio ranging from 1:5 to 5:1.

In another embodiment, the present invention provides a liquid insecticidal composition comprising a tetramic acid derivative and one or more dispersing agents comprising a non-ionic copolymer and an anionic dispersant, and agrochemically acceptable excipients, wherein the non-ionic copolymer and the anionic dispersant is in a ratio ranging from 1:15 to 15:1.

In another embodiment, the present invention provides a liquid insecticidal composition comprising a tetramic acid derivative and one or more dispersing agents comprising a non-ionic copolymer and an anionic dispersant, and agrochemically acceptable excipients, wherein the non-ionic copolymer and the anionic dispersant is in a ratio ranging from 1:10 to 10:1.

In another embodiment, the present invention provides a liquid insecticidal composition comprising a tetramic acid derivative and one or more dispersing agents comprising a non-ionic copolymer and an anionic dispersant, and agrochemically acceptable excipients, wherein the non-ionic copolymer and the anionic dispersant is in a ratio ranging from 1:5 to 5:1.

In another aspect, present invention provides a liquid insecticidal composition comprising spirotetramat and one or more dispersing agents comprising a non-ionic copolymer and an anionic dispersant, and agrochemically acceptable excipients, wherein the non-ionic copolymer and the anionic dispersant is in a ratio ranging from 1:15 to 15:1.

In another aspect, the present invention provides a liquid insecticidal composition comprising spirotetramat and one or more dispersing agents comprising a non-ionic copolymer, and an anionic dispersant and agrochemically acceptable excipients, wherein the non-ionic copolymer and the anionic dispersant is in a ratio ranging from 1:10 to 10:1.

In another aspect, the present invention provides a liquid insecticidal composition comprising spirotetramat and one or more dispersing agents comprising a non-ionic copolymer and an anionic dispersant and agrochemically acceptable excipients, wherein the non-ionic copolymer and the anionic dispersant is in a ratio ranging from 1:5 to 5:1.

In a more preferred embodiment, the non-ionic copolymer and anionic dispersant are present in a ratio ranging from of 1:2 to 2:1.

In a more preferred embodiment, the non-ionic copolymer and anionic dispersant are present in a ratio of 1:1.

In a preferred embodiment, the tetramic acid derivative insecticide is in a concentration ranging from 20% w/v to 80% w/v.

In an embodiment, the tetramic acid derivative insecticide is in a concentration ranging from 30% w/v to 80% w/v.

In a preferred embodiment, the tetramic acid derivative insecticide is in a concentration ranging from 30% w/v to 70% w/v.

In a more preferred embodiment, the tetramic acid derivative insecticide is in a concentration ranging from 30% w/v to 60% w/v.

In another preferred embodiment, the tetramic acid derivative insecticide is in a concentration ranging from 30% w/v to 50% w/v.

In another preferred embodiment, the tetramic acid derivative insecticide is in a concentration ranging from 30% w/v to 40% w/v.

In another preferred embodiment, the tetramic acid derivative insecticide is in a concentration of 36% w/v.

In an embodiment, spirotetramat is in a concentration ranging from 20% w/v to 80% w/v.

In an embodiment, spirotetramat is in a concentration ranging from 30% w/v to 80% w/v.

In a preferred embodiment, spirotetramat is in a concentration ranging from 30% w/v to 70% w/v.

In a more preferred embodiment, spirotetramat is in a concentration ranging from 30% w/v to 60% w/v.

In another preferred embodiment, spirotetramat is in a concentration ranging from 30% w/v to 50% w/v.

In another preferred embodiment, spirotetramat is in a concentration ranging from 30% w/v to 40% w/v.

In another preferred embodiment, spirotetramat is in a concentration of 36% w/v.

In a preferred embodiment, references to ≥300 g/L of tetramic acid derivative insecticide refer to concentrations ranging from 300 to 800 g/L. In a more preferred embodiment, references to ≥300 g/L of tetramic acid derivative insecticide refer to concentrations ranging from 300 to 600 g/L.

In an embodiment, the tetramic acid derivative insecticide is in a concentration ranging from 300 g/L to 800 g/L.

In a preferred embodiment, the tetramic acid derivative insecticide is in a concentration ranging from 300 g/L to 700 g/L.

In a more preferred embodiment, the tetramic acid derivative insecticide is in a concentration ranging from 300 g/L to 600 g/L.

In a preferred embodiment, the tetramic acid derivative insecticide is in a concentration ranging from 300 g/L to 500 g/L.

In a preferred embodiment, the tetramic acid derivative insecticide is in a concentration ranging from 300 g/L to 400 g/L.

In a most preferred embodiment, the tetramic acid derivative insecticide is in a concentration of 360 g/L.

In a preferred embodiment, references to ≥300 g/L of spirotetramat refer to concentrations ranging from 300 to 800 g/L.

In a more preferred embodiment, references to ≥300 g/L of spirotetramat refer to concentrations ranging from 300 to 600 g/L.

In an embodiment, spirotetramat is in a concentration ranging from 200 g/L to 800 g/L.

In an embodiment, spirotetramat insecticide is in a concentration ranging from 300 g/L to 800 g/L.

In a preferred embodiment, spirotetramat insecticide is in a concentration ranging from 300 g/L to 700 g/L.

In a more preferred embodiment, spirotetramat is in a concentration ranging from 300 g/L to 600 g/L.

In a preferred embodiment, spirotetramat is in a concentration ranging from 300 g/L to 500 g/L.

In a preferred embodiment, spirotetramat is in a concentration ranging from 300 g/L to 400 g/L.

In a preferred embodiment, spirotetramat is in a concentration of 360 g/L.

In an embodiment, the dispersing agents are present in a concentration ranging from 1% w/v to 20% w/v.

In another embodiment, the dispersing agents are present in a concentration ranging from 1% w/v to 10% w/v.

In another embodiment, the dispersing agents are present in a concentration ranging from 1% w/v to 6% w/v.

In an embodiment, the non-ionic copolymer is present in a concentration ranging from 1% w/v to 10% w/v.

In an embodiment, the non-ionic copolymer is present in a concentration ranging from 1% w/v to 6% w/v.

In an embodiment, the non-ionic copolymer is present in a concentration ranging from 1% w/v to 3% w/v.

In an embodiment, the anionic dispersant is present in a concentration ranging from 1% w/v to 10% w/v.

In an embodiment, the anionic dispersant is present in a concentration ranging from 1% w/v to 6% w/v.

In an embodiment, the anionic dispersant is present in a concentration ranging from 1% w/v to 3% w/v.

In an embodiment, the polymethyl methacrylate-polyethylene glycol graft copolymer is in a concentration ranging from 1% w/v to 6% w/v.

In an embodiment, the polymethyl methacrylate-polyethylene glycol graft copolymer is in a concentration ranging from 1% w/v to 3% w/v.

In an embodiment, the alkali salt of naphthalene sulfonate condensate is in a concentration ranging from 1% w/v to 10% w/v.

In an embodiment, the alkali salt of naphthalene sulfonate condensate is in a concentration ranging from 1% w/v to 6% w/v.

In an embodiment, the alkali salt of naphthalene sulfonate condensate is in a concentration ranging from 1% w/v to 3% w/v.

In an embodiment, the sodium salt of naphthalene sulfonate condensate is in a concentration ranging from 1% w/v to 10% w/v.

In an embodiment, the sodium salt of naphthalene sulfonate condensate is in a concentration ranging from 1% w/v to 6% w/v.

In an embodiment, the sodium salt of naphthalene sulfonate condensate is in a concentration ranging from 1% w/v to 3% w/v.

The stable insecticidal composition of the present invention further comprises one or more dispersants, pH regulating agent, preservatives, biocides, antifoam agents, anti-freeze agents, thickeners, solvent/carriers and other formulation aids.

The pH regulating agent is a weak acid. The weak acid is selected from one or more of weak organic acids and weak inorganic acids. The weak inorganic acid is selected from one or more of phosphoric acid, ortho-phosphoric acid, boric acid, citric acid, sulphurous acid, nitrous acid, and hydrofluoric acid. The weak organic acid is selected from one or more of oxalic acid, methanoic acid, benzoic acid, fumaric acid, acetic acid, propionic acid, tartaric acid, and succinic acid. The pH regulating agent is used to adjust the pH of the composition in the range of 3.5-4.5 since spirotetramat has better hydrolysis resistance at pH of around 4.

In a preferred embodiment, the weak acid is ortho-phosphoric acid.

In another embodiment, the composition comprises a pH regulating agent in a concentration range of 0.01% w/v to 0.1% w/v.

In a specific embodiment, the pH regulating agent is present in a concentration range of 0.02% w/v to 0.08% w/v.

In an embodiment of the present invention, the anti-freeze agent is selected from ethylene glycol, propylene glycol, glycerin, diethylene glycol, triethylene glycol, polyethylene glycol.

In one embodiment, the anti-freeze agent is present in a concentration range of 0.1% w/v to 10% w/v based on the total weight of the composition and preferably in a concentration range of 3% w/v to 8% w/v based on the total weight of the composition.

In an embodiment of the present invention the antifoam agent is polyorganosiloxane liquid or silicon-based antifoam. More preferably, the antifoam agent is aqueous emulsion of polydimethylsiloxane oil. Defoamers that are suitable include SAG-1572; and Silcolapse® 426 R.

In one embodiment, the antifoam agent is present in a concentration range of 0.01% w/v to 3% w/v based on the total weight of the composition and preferably in a concentration range of 0.1% w/v to 1% w/v based on the total weight of the composition.

In an embodiment of the present invention the thickener can be selected from the group comprising of xanthan gum, carboxy methyl cellulose, hydroxymethyl propyl cellulose. The thickener is preferably xanthan gum. Examples of thickening agents based on anionic heteropolysaccharides from the xanthan gum group are inter alia the Rhodopol 23®, Rhodopol G®, Rhodopol 50 MD®, Rhodicare TR, Kelzan®, Kelzan S® and Satiaxane CX91®.

In one embodiment, the thickener is present in a concentration range of 0.01% w/v to 3% w/v based on the total weight of the composition and preferably in a concentration range of 0.1% w/v to 1% w/v based on the total weight of the composition.

In another embodiment, the biocide is selected from isothiazolinone, isothiazolinone mixture, benzisothiazolinone or combination thereof. More preferably, the biocide is an aqueous dipropylene glycol solution of 1,2-benzisothiazolin-3-one (Proxel GXL).

In one embodiment, the biocide is present in a concentration range of 0.01% w/v to 3% w/v based on the total weight of the composition and preferably in a concentration range of 0.1% w/v to 1% w/v based on the total weight of the composition.

In an embodiment of the present invention, water is used as a solvent/carrier/diluent to dilute the active ingredient to a desired concentration. The water used is purified water and selected from the group consisting of deionized water and distilled water.

In one embodiment, the water is present in a concentration range of 30% w/v to 80% w/v based on the total weight of the composition and preferably in a concentration range of 40% w/v to 70% w/v based on the total weight of the composition.

In one embodiment, the present disclosure provides a stable liquid insecticidal composition comprising:
a) at least one tetramic acid derivative insecticide,
b) one or more dispersing agents comprising a non-ionic copolymer and an anionic dispersant in a ratio ranging from 1:15 to 15:1,
c) at least one pH regulating agent,
d) at least one antifoam agent,
e) at least one anti-freeze agent,
f) at least one thickener,
g) at least one biocide, and
h) at least one carrier.

In one embodiment, the present disclosure provides a stable liquid insecticidal composition comprising:
a) at least one tetramic acid derivative insecticide,
b) one or more dispersing agents comprising a non-ionic copolymer and an anionic dispersant in a ratio ranging from 1:10 to 10:1,
c) at least one pH regulating agent,
d) at least one antifoam agent,
e) at least one anti-freeze agent,
f) at least one thickener,
g) at least one biocide, and
h) at least one carrier.

In one embodiment, the present disclosure provides a stable liquid insecticidal composition comprising:
a) at least one tetramic acid derivative insecticide,
b) one or more dispersing agents comprising a non-ionic copolymer and an anionic dispersant in a ratio ranging from 1:5 to 5:1,
c) at least one pH regulating agent,
d) at least one antifoam agent,
e) at least one anti-freeze agent,
f) at least one thickener,
g) at least one biocide, and
h) at least one carrier.

In one embodiment, the present disclosure provides a stable liquid insecticidal composition comprising:
a) at least one tetramic acid derivative insecticide,
b) one or more dispersing agents comprising a non-ionic copolymer and an anionic dispersant in a ratio ranging from 1:2 to 2:1,
c) at least one pH regulating agent,
d) at least one antifoam agent,
e) at least one anti-freeze agent,
f) at least one thickener,
g) at least one biocide, and
h) at least one carrier.

In another embodiment, the present disclosure provides a stable liquid insecticidal composition comprising:
a) at least one tetramic acid derivative insecticide,
b) one or more dispersing agents comprising a non-ionic copolymer and an anionic dispersant in a ratio of 1:1,
c) at least one pH regulating agent,
d) at least one antifoam agent,
e) at least one anti-freeze agent,
f) at least one thickener,
g) at least one biocide, and
h) at least one carrier.

In another embodiment, the present disclosure provides a stable liquid insecticidal composition comprising:
a) at least one tetramic acid derivative insecticide in a concentration range of 30% wt to 60% wt,
b) one or more dispersing agents comprising a non-ionic copolymer and an anionic dispersant in a concentration range of 1% wt to 10% wt,
c) at least one pH regulating agent in a concentration range of 0.01% wt to 0.1% wt,
d) at least one antifoam agent in a concentration range of 0.01% wt to 3% wt,
e) at least one anti-freeze agent in a concentration range of 0.1% wt to 10% wt,
f) at least one thickener in a concentration range of 0.01% wt to 3% wt,
g) at least one biocide in a concentration range of 0.01% wt to 3% wt
h) at least one carrier in a concentration range of 30% wt to 80% wt wherein the non-ionic copolymer and the anionic dispersant are present in a ratio ranging from 1:15 to 15:1 and the wt % is based on the total weight of the composition.

In another embodiment, the present disclosure provides a stable liquid insecticidal composition comprising:
a) at least one tetramic acid derivative insecticide in a concentration range of 30% wt to 50% wt,
b) a non-ionic copolymer in a concentration range of 1% wt to 5% wt,
c) an anionic dispersant in a concentration range of 1% wt to 5% wt,
d) at least one pH regulating agent in a concentration range of 0.02% wt
to 0.08% wt,
e) at least one antifoam agent in a concentration range of 0.1% wt to 1% wt,
f) at least one anti-freeze agent in a concentration range of 3% wt to 8% wt
g) at least one thickener in a concentration range of 0.1% wt to 1% wt,
h) at least one biocide in a concentration range of 0.1% wt to 1% wt,
i) at least one carrier in a concentration range of 40% wt to 70% wt,
   wherein the non-ionic copolymer and the anionic dispersant are present in a ratio ranging from 1:10 to 10:1 and the wt % is based on the total weight of the composition.

The compositions that can be used in the present invention include both solid and liquid based compositions. In a preferred embodiment, the composition is a liquid composition. Non-limiting examples of suitable liquid compositions may be emulsion concentrates (EC), suspension concentrates (SC), capsule suspensions (CS), oil dispersion (OD); suitable solid compositions may be water dispersible granules (WDG) and wettable powders (WP), dusts and the like. In a preferred embodiment, the composition is suspension concentrate.

In a preferred embodiment, the composition is a suspension concentrate (SC).

In an embodiment, present invention provides a suspension concentrate comprising a tetramic acid derivative and one or more dispersing agents comprising a non-ionic copolymer and an anionic dispersant, and agrochemically acceptable excipients, wherein the non-ionic copolymer and the anionic dispersant is in a ratio ranging from 1:15 to 15:1.

In an embodiment, the present invention provides a suspension concentrate comprising tetramic acid derivative and one or more dispersing agents comprising a non-ionic copolymer, and an anionic dispersant and agrochemically acceptable excipients, wherein the non-ionic copolymer and the anionic dispersant is in a ratio ranging from 1:10 to 10:1.

In an embodiment, the present invention provides a suspension concentrate comprising tetramic acid derivative and one or more dispersing agents comprising a non-ionic copolymer and an anionic dispersant and agrochemically acceptable excipients, wherein the non-ionic copolymer and the anionic dispersant is in a ratio ranging from 1:5 to 5:1.

In an embodiment, the present invention provides a suspension concentrate comprising tetramic acid derivative and one or more dispersing agents comprising a non-ionic copolymer and an anionic dispersant and agrochemically acceptable excipients, wherein the non-ionic copolymer and the anionic dispersant is in a ratio of 1:1.

In an embodiment, present invention provides a suspension concentrate comprising spirotetramat and one or more dispersing agents comprising a non-ionic copolymer and an anionic dispersant, and agrochemically acceptable excipients, wherein the non-ionic copolymer and the anionic dispersant is in a ratio ranging from 1:15 to 15:1.

In an embodiment, the present invention provides a suspension concentrate comprising spirotetramat and one or more dispersing agents comprising a non-ionic copolymer, and an anionic dispersant and agrochemically acceptable excipients, wherein the non-ionic copolymer and the anionic dispersant is in a ratio ranging from 1:10 to 10:1.

In an embodiment, the present invention provides a suspension concentrate comprising spirotetramat and one or more dispersing agents comprising a non-ionic copolymer and an anionic dispersant and agrochemically acceptable excipients, wherein the non-ionic copolymer and the anionic dispersant is in a ratio ranging from 1:5 to 5:1.

In an embodiment, the present invention provides a suspension concentrate comprising spirotetramat and one or more dispersing agents comprising a non-ionic copolymer and an anionic dispersant and agrochemically acceptable excipients, wherein the non-ionic copolymer and the anionic dispersant is in a ratio of 1:1.

In an embodiment, the present invention provides a suspension concentration formulation comprising;
(a) ≥300 g/L of spirotetramat,
(b) polymethyl methacrylate-polyethylene glycol graft copolymer,
(c) sodium salt of naphthalene sulfonate condensate,
(d) agriculturally acceptable excipients,
   wherein the polymethyl methacrylate-polyethylene glycol graft copolymer and the sodium salt of naphthalene sulfonate condensate is in a ratio ranging from 1:10 to 10:1.

In an embodiment, the present invention provides a suspension concentration formulation comprising;
(i) ≥300 g/L of spirotetramat,
(ii) polymethyl methacrylate-polyethylene glycol graft copolymer,
(iii) sodium salt of naphthalene sulfonate condensate,
(iv) agriculturally acceptable excipients,
   wherein the polymethyl methacrylate-polyethylene glycol graft copolymer and the sodium salt of naphthalene sulfonate condensate is in a ratio ranging from 1:5 to 5:1.

In an embodiment, the present invention provides a suspension concentration formulation comprising;
(i) ≥300 g/L of spirotetramat,
(ii) polymethyl methacrylate-polyethylene glycol graft copolymer,
(iii) sodium salt of naphthalene sulfonate condensate,
(iv) agriculturally acceptable excipients,
   wherein the polymethyl methacrylate-polyethylene glycol graft copolymer and the sodium salt of naphthalene sulfonate condensate is in a ratio ranging from 1:2 to 2:1.

In an embodiment, the present invention provides a suspension concentration formulation comprising;
(i) ≥300 g/L of spirotetramat,
(ii) polymethyl methacrylate-polyethylene glycol graft copolymer,
(iii) sodium salt of naphthalene sulfonate condensate,
(iv) agriculturally acceptable excipients,
   wherein the polymethyl methacrylate-polyethylene glycol graft copolymer and the sodium salt of naphthalene sulfonate condensate is in a ratio of 1:1.

In a more preferred embodiment, the suspension concentrate comprises spirotetramat in a concentration ranging from 300 g/L to 600 g/L.

In a preferred embodiment, the suspension concentrate comprises spirotetramat in a concentration ranging from 300 g/L to 500 g/L.

In a preferred embodiment, the suspension concentrate comprises spirotetramat in a concentration ranging from 300 g/L to 400 g/L.

In a most preferred embodiment, the suspension concentrate comprises spirotetramat in a concentration of 360 g/L.

In an embodiment, the present disclosure provides a suspension concentrate comprising:
(i) spirotetramat,
(ii) polymethyl methacrylate-polyethylene glycol graft copolymer,
(iii) sodium salt of naphthalene sulfonate condensate,
(iv) aqueous solution of ortho-phosphoric acid,
(v) aqueous emulsion of polydimethylsiloxane oil,
(vi) aqueous dipropylene glycol solution of 1, 2-benzisothiazolin-3-one,
(vii) water
   wherein the polymethyl methacrylate-polyethylene glycol graft copolymer and the sodium salt of naphthalene sulfonate condensate are present in a ratio ranging from 1:15 to 15:1.

In an embodiment, the present disclosure provides a suspension concentrate comprising:
a) spirotetramat,
b) polymethyl methacrylate-polyethylene glycol graft copolymer,
c) sodium salt of naphthalene sulfonate condensate,
c) aqueous solution of ortho-phosphoric acid,
d) aqueous emulsion of polydimethylsiloxane oil,
e) aqueous dipropylene glycol solution of 1, 2-benzisothiazolin-3-one, and
f) water,
   wherein the polymethyl methacrylate-polyethylene glycol graft copolymer and the sodium salt of naphthalene sulfonate condensate are in a ratio ranging from 1:10 to 10:1.

In an embodiment, the present disclosure provides a suspension concentrate comprising:
a) spirotetramat,
b) polymethyl methacrylate-polyethylene glycol graft copolymer,
c) sodium salt of naphthalene sulfonate condensate,
c) aqueous solution of ortho-phosphoric acid,
d) aqueous emulsion of polydimethylsiloxane oil,
e) aqueous dipropylene glycol solution of 1, 2-benzisothiazolin-3-one,
f) water,
   wherein the polymethyl methacrylate-polyethylene glycol graft copolymer and the sodium salt of naphthalene sulfonate condensate are in a ratio ranging from 1:5 to 5:1.

In an embodiment, the present disclosure provides a suspension concentrate comprising:
a) spirotetramat,
b) polymethyl methacrylate-polyethylene glycol graft copolymer,
c) sodium salt of naphthalene sulfonate condensate,
c) aqueous solution of ortho-phosphoric acid,
d) aqueous emulsion of polydimethylsiloxane oil,
e) aqueous dipropylene glycol solution of 1, 2-benzisothiazolin-3-one,
f) water,
   wherein the polymethyl methacrylate-polyethylene glycol graft copolymer and the sodium salt of naphthalene sulfonate condensate are in a ratio of 1:1.

In a particular embodiment, the present disclosure provides a suspension concentrate comprising:
a) spirotetramat in a concentration range of 20% w/v to 80% w/v,
b) polymethyl methacrylate-polyethylene glycol graft copolymer in a concentration range of 1% w/v to 5% w/v,
c) sodium salt of naphthalene sulfonate condensate in a concentration range of 1% w/v to 5% w/v,
c) aqueous solution of ortho-phosphoric acid in a concentration range of 0.02% w/v to 0.08% w/v,
d) aqueous emulsion of polydimethylsiloxane oil in a concentration range of 0.1% w/v to 1% w/v,
e) glycerin in a concentration range of 3% w/v to 8% w/v,
f) xanthan gum in a concentration range of 0.1% w/v to 1% w/v,
g) aqueous dipropylene glycol solution of 1, 2-benzisothiazolin-3-one in a concentration range of 0.1% w/v to 1% w/v,
h) water in a concentration range of 40% w/v to 70% w/v,
   wherein the polymethyl methacrylate-polyethylene glycol graft copolymer and the sodium salt of naphthalene sulfonate condensate are in a ratio ranging from 1:10 to 10:1 and the % w/v is based on the total weight of the composition.

In a particular embodiment, the present disclosure provides a suspension concentrate comprising:
a) spirotetramat in a concentration range of 30% w/v to 70% w/v,
b) polymethyl methacrylate-polyethylene glycol graft copolymer in a concentration range of 1% w/v to 5% w/v,
c) sodium salt of naphthalene sulfonate condensate in a concentration range of 1% w/v to 5% w/v,
c) aqueous solution of ortho-phosphoric acid in a concentration range of 0.02% w/v to 0.08% w/v,
d) aqueous emulsion of polydimethylsiloxane oil in a concentration range of 0.1% w/v to 1% w/v,
e) glycerin in a concentration range of 3% w/v to 8% w/v,
f) xanthan gum in a concentration range of 0.1% w/v to 1% w/v,
g) aqueous dipropylene glycol solution of 1, 2-benzisothiazolin-3-one in a concentration range of 0.1% w/v to 1% w/v,
h) water in a concentration range of 40% w/v to 70% w/v,
   wherein the polymethyl methacrylate-polyethylene glycol graft copolymer and the sodium salt of naphthalene sulfonate condensate are in a ratio ranging from 1:10 to 10:1 and the % w/v is based on the total weight of the composition.

In a particular embodiment, the present disclosure provides a suspension concentrate comprising:
a) spirotetramat in a concentration range of 30% w/v to 60% w/v,
b) polymethyl methacrylate-polyethylene glycol graft copolymer in a concentration range of 1% w/v to 5% w/v,
c) sodium salt of naphthalene sulfonate condensate in a concentration range of 1% w/v to 5% w/v,
c) aqueous solution of ortho-phosphoric acid in a concentration range of 0.02% w/v to 0.08% w/v,
d) aqueous emulsion of polydimethylsiloxane oil in a concentration range of 0.1% w/v to 1% w/v,
e) glycerin in a concentration range of 3% w/v to 8% w/v,
f) xanthan gum in a concentration range of 0.1% w/v to 1% w/v,
g) aqueous dipropylene glycol solution of 1, 2-benzisothiazolin-3-one in a concentration range of 0.1% w/v to 1% w/v,
h) water in a concentration range of 40% w/v to 70% w/v,
   wherein the polymethyl methacrylate-polyethylene glycol graft copolymer and the sodium salt of naphthalene sulfonate condensate are in a ratio ranging from 1:10 to 10:1 and the % w/v is based on the total weight of the composition.

In an embodiment, the pH of the suspension concentrate was maintained at 3 to 5 by incorporating ortho-phosphoric acid solution.

In an embodiment, the pH of the composition was maintained at 3.5-4.5 by incorporating ortho-phosphoric acid solution.

In an embodiment, the present invention provides a process for preparation of a suspension concentrate.

In an embodiment, the present invention provides a process for preparing a suspension concentrate formulation comprising ≥300 g/L of a tetramic acid derivative insecticide, the process comprising;
(a) mixing a tetramic acid insecticide with a non-ionic copolymer and an anionic dispersant to obtain a homogenous blend,
(b) milling the blend of step (a) to achieve a mill base having a D (90) particle size ranging from 0.1 to 10 μm,
(c) preparing a thickener mix, and
(d) mixing the tetramic acid insecticide blend, the thickener mix and excipients to produce the suspension concentrate formulation;
   wherein the non-ionic copolymer and anionic dispersant is in a ratio ranging from 1:10 to 10:1.

In an embodiment, a process of preparing the composition comprises:
a) Preparing a tetramic acid insecticide mill base (A) by using water, anti-freeze agent, antifoam agent, non-ionic copolymer, and an anionic dispersant,
b) Preparing a thickener mix (B) using thickener, biocide, and anti-freeze agent, and
c) Mixing the tetramic acid insecticide mill base (A), the thickener mix (B), antifoam agent, pH regulating agent and water to produce the final composition.

In a specific embodiment, a process of preparing a tetramic acid insecticide mill base (A) comprises:
a) Charging a suitable vessel with water, anti-freeze agent, antifoam agent, non-ionic copolymer and mixing until a homogeneous solution is formed,
b) Adding and mixing an anionic dispersant to the homogenous solution of step a) to achieve a homogeneous mixture,
c) Incorporating a tetramic acid insecticide into the homogenous mixture of step b) using high shear mixing to provide a homogenous blend,
d) Reducing mixing speed after no visible clumps are detected and maintaining enough agitation to prevent settling,
e) Milling the homogenous blend in a milling chamber at a specific temperature to achieve a mill base having a D (90) particle size in the range of 0.1-10 μm.

In a further embodiment, the milling of step e) is carried out using horizontal wet bead mill.

In a specific embodiment, the homogenous blend is milled twice in step e) to achieve the mill base having D (90) particle size in the range of 0.1-10 μm.

Preferably, the mill base has a D (90) particle size in the range of 2-8 μm.

In a preferred embodiment, mill outlet temperature in step e) should be maintained in the range of 10 to 35° C. throughout the milling process using a cooling system.

In another specific embodiment, a process of preparing a thickener mix (B) comprises:
a) Charging a suitable vessel with an anti-freeze agent and a biocide to form a liquid phase,
b) Blending a thickener into the liquid phase of step a) with stirring and mixing until the thickener is dispersed in the liquid phase,
c) Adding, mixing, and stirring water into the liquid phase of step b) until homogeneous to prepare the thickener mix (B).

In an embodiment, a process of preparing a tetramic acid insecticide composition comprises:
a) Charging a suitable vessel with tetramic acid insecticide mill-base (A), thickener mix (B), antifoam agent and water and stirring to produce a homogenous mixture,
b) Integrating a pH regulating agent (85%) into the homogenous mixture of step a) and maintaining pH of the homogenous mixture in the range of 3.5-4.5 to achieve final suspension concentrate composition,
c) Testing specifications of the composition and filtering it to remove any extraneous matter before packaging.

In one embodiment, the present disclosure provides a novel composition for controlling wide variety of pests such as chewing, boring, and sucking insects in targeted crops.

In an embodiment, the crops can be selected from but not limited to cereals, such as wheat, oats, barley, spelt, triticale, rye, maize, millet, rice, crops such as sugarcane, soybean, sunflower, rape, canola, tobacco, sugar beet, fodder beet; tuber crops such as potatoes, sweet potatoes etc., crops such as asparagus, hops etc.; fruit plants such as apples, pears, stone-fruits such as for example peaches, nectarines, cherries, plums, apricots, citrus fruits such as oranges, grapefruit, limes, lemons, kumquats, mandarins, satsumas; nuts such as pistachios, almonds, walnuts, pecan nuts, tropical fruits such as mango, papaya, pineapple, dates, bananas etc., grapes, vegetables such as endives, lambs, lettuce, fennel, globe and loose-leaf salad, chard, spinach, chicory, cauliflower, broccoli, Chinese cabbage, kale (winter kale or curly kale), kohlrabi, Brussel sprouts, red cabbage, white cabbage and savoy, fruiting vegetables such as aubergines, cucumbers, paprika, marrow, tomatoes, courgettes, sweetcorn, root vegetables such as celeriac, turnip, carrots, swedes, radishes, horse radish, beetroot, salsify, celery, pulses such as peas, beans etc., bulb vegetables such as leeks, onions etc., oil crops such as mustard, poppy, olives, sunflowers, coconut, castor oil plants, cocoa beans, groundnuts; fibre crops such as cotton, jute, flex, hemp, crops such as tea, coffee, rubber, ornamentals including shrubs and flowering plants, vines, rangeland, and pastures.

In an embodiment, the present composition is effective against all developmental stages of insect pests such as egg, larva, pupa, and adult, and preferred stages controlled are eggs and larvae.

The pests may be controlled by contacting the target pest, its food supply, habitat, breeding ground or its locus with a pesticidally effective amount of the present composition.

In an embodiment the present invention provides use of stable insecticidal composition comprising spirotetramat for controlling insects.

In another aspect, the present disclosure provides a method for controlling or preventing pests on plants or propagation material thereof by simultaneously or sequentially applying the present composition comprising spirotetramat. The present composition may be admixed with one or more additional active ingredients such as an insecticide, fungicide, synergist, herbicide, or plant growth regulator where appropriate.

According to another embodiment, the present disclosure provides a method of controlling or preventing pests on plants or propagation material thereof, said method comprising applying an agrochemically effective amount of present composition to the pests or to the plants or to their locus.

According to another embodiment, the present disclosure provides a method of controlling or preventing pests on plants or propagation material thereof, said method comprising applying an insecticidally effective amount of insecticidal composition to the pests or to the plants or to their locus.

According to another embodiment, the present disclosure provides a method of controlling or preventing pests on plants or propagation material thereof, said method comprising applying an insecticidally effective amount of an insecticidal composition to the pests or to the plants or to their locus, the composition comprising;
(a) ≥300 g/L of spirotetramat,
(b) polymethyl methacrylate-polyethylene glycol graft copolymer,
(c) sodium salt of naphthalene sulfonate condensate,
(d) agriculturally acceptable excipients,
   wherein the polymethyl methacrylate-polyethylene glycol graft copolymer and the sodium salt of naphthalene sulfonate condensate is in a ratio ranging from 1:10 to 10:1.

According to another embodiment, the present disclosure provides a method of controlling or preventing pests on plants or propagation material thereof, said method comprising applying an insecticidally effective amount of an insecticidal composition to the pests or to the plants or to their locus, the composition comprising;
(a) ≥300 g/L of spirotetramat,
(b) polymethyl methacrylate-polyethylene glycol graft copolymer,
(c) sodium salt of naphthalene sulfonate condensate,
(d) agriculturally acceptable excipients,
   wherein the polymethyl methacrylate-polyethylene glycol graft copolymer and the sodium salt of naphthalene sulfonate condensate is in a ratio ranging from 1:5 to 5:1.

In an embodiment, the present disclosure provides a method of predominantly controlling target insect infestation at a locus, said method comprising administering to the locus of infestation the present composition. The administration is preferably by application either when first signs of infestation are seen or when insect pests begin to reappear.

The present invention provides a method of controlling insects comprising applying the present suspension concentrate formulation and an additional agrochemical.

In an embodiment, the additional agrochemical comprises at least one pesticide selected from the group comprising acaricides, algicides, avicides/bird repellents, bactericides, fungicides, herbicide safeners, herbicides, insect attractants, insect chemosterilants, insect repellents, insecticides, mammal repellents, molluscicides, nematicides, nitrification inhibitors, plant activators, plant growth regulators, rodenticides, synergists, virucides, and combinations thereof.

The invention also provides a kit comprising insecticidal compositions comprising spirotetramat for controlling insecticidal diseases and instructions for use. The instructions for use typically comprise instructions for the application of the present prothioconazole combinations to the locus.

In an embodiment, the kit comprises:
(i) ≥300 g/L of spirotetramat,
(ii) polymethyl methacrylate-polyethylene glycol graft copolymer,
(iii) sodium salt of naphthalene sulfonate condensate,
(iv) agriculturally acceptable excipients,
   wherein the polymethyl methacrylate-polyethylene glycol graft copolymer and the sodium salt of naphthalene sulfonate condensate is in a ratio ranging from 1:5 to 5:1.

In an embodiment, the kit comprises:
(i) ≥300 g/L of spirotetramat,
(ii) polymethyl methacrylate-polyethylene glycol graft copolymer,
(iii) sodium salt of naphthalene sulfonate condensate,
(iv) agriculturally acceptable excipients,
   wherein the polymethyl methacrylate-polyethylene glycol graft copolymer and the sodium salt of naphthalene sulfonate condensate is in a ratio ranging from 1:2 to 2:1.

In an embodiment, the kit comprises:
(i) ≥300 g/L of spirotetramat,
(ii) polymethyl methacrylate-polyethylene glycol graft copolymer,
(iii) sodium salt of naphthalene sulfonate condensate,
(iv) agriculturally acceptable excipients,
   wherein the polymethyl methacrylate-polyethylene glycol graft copolymer and the sodium salt of naphthalene sulfonate condensate is in a ratio of 1:1.

The invention shall now be described with reference to the following specific examples. It should be noted that the examples appended below illustrate rather than limit the invention and that those skilled in the art will be able to design many alternative embodiments without departing from the scope of the present invention.

### EXAMPLES

### Example 1: Spirotetramat 360 g/L Suspension Concentrate (SC)

TABLE 1

| Ingredient | g/L |
|---|---|
| Spirotetramat | 378.95 |
| Polymethyl methacrylate-polyethylene glycol graft | 28.50 |
| copolymer | |
| Sodium salt of naphthalene sulfonate condensate | 28.50 |
| Aqueous emulsion of polydimethylsiloxane oil | 2.50 |
| Xanthan gum | 3.00 |
| Aqueous dipropylene glycol solution of 1,2- | 3.00 |
| benzisothiazolin-3-one | |
| Ortho-phosphoric acid 85% aqueous solution | 0.56 |
| Water | Q.S. |
| Total | 1 L |

### Example 2: Spirotetramat 360 g/L Suspension Concentrate (SC)

TABLE 2

| Ingredient | % (w/v) | g/L |
|---|---|---|
| Spirotetramat | 33.33% | 360.00 |
| Polymethyl methacrylate-polyethylene | 2.64% | 28.50 |
| glycol graft copolymer | | |
| Sodium salt of naphthalene sulfonate | 2.64% | 28.50 |
| condensate | | |
| Aqueous emulsion of | 0.23% | 2.50 |
| polydimethylsiloxane oil | | |
| Xanthan gum | 0.25% | 2.75 |
| 1,2-benzisothiazolin-3-one based | 0.25% | 2.75 |
| preservative | | |
| 85% Ortho-phosphoric acid aqueous | 0.05% | 0.56 |
| solution | | |
| Water | Q.S. | Q.S. |
| Total | 100 | 1 L |

Q.S.: quantity sufficient

### Process:

Polydimethylsiloxane oil aqueous solution, polymethyl methacrylate-polyethylene glycol graft copolymer, sodium salt of naphthalene sulfonate condensate, spirotetramat were mixed in a vessel to form a homogenous mixture. The homogenous mixture was subject to high shear mixing and milling in a horizontal wet bead mill to prepare a spirotetramat mill base having a D (90) ≤7 μm. Aqueous dipropylene glycol solution of 1,2-benzisothiazolin-3-one, xanthan gum and water were mixed to provide a thickener mix. spirotetramat mill base, polydimethylsiloxane oil aqueous solution, water were stirred and mixed to form a homogenous mixture to which 85% Ortho-phosphoric acid aqueous solution and water were added to produce the final spirotetramat suspension concentrate. The pH of the composition was maintained at 3.5-4.5 by incorporating additional ortho-phosphoric acid solution if necessary.

### Example 3: Chemical Stability Data

The extent of chemical degradation and physical change in the active under exaggerated storage conditions was ascertained using accelerated stability studies. Spirotetramat (A.I) 360 g/L suspension concentrate was used in said stability studies.

TABLE 3
Chemical stability assessment

| Interval | Temp(° C.) | [A.I.] (%, w/w) | Recovery (%) |
|---|---|---|---|
| Initial | RT | 33.74 | — |
| 2 weeks | 54 | 34.11 | 101.10% |
| 2 months | 40 | 33.58 | 99.53% |
| (8 weeks) | | | |
| 3 months | 40 | 33.91 | 100.50% |
| (12 weeks) | | | |
| 5 months | 30 | 34.30 | 101.66% |
| (18 weeks) | 40 | 34.01 | 100.80% |

A.I: Active ingredient,
RT: room temperature

It is evident from the above Table 3 that the present composition Spirotetramat suspension concentrate was able to withstand accelerated temperature conditions of 54° C. (AHS) and is stable up to 18 months at about 30° C. and 40° C.

### Physical Stability Assessment

TABLE 4
Assessment to determine change in appearance and weight

| Storage | Storage | | Weight |
|---|---|---|---|
| Interval | Temp. (° C.) | Appearance | Change |
| Initial | N/A | Opaque, biege, flowable | N/A |
| | | liquid. | |
| 2 weeks | 54 | Surface: Opaque, beige | 1.44% |
| | | flowable liquid. No | |
| | | observable surface bleed. | |
| | | No pack defects. | |

The data presented in Table 4 shows that over a period of 2 weeks, the present composition continues to be an opaque, beige, flowable liquid which does not exhibit significant weight change even after being subject to high temperatures of up to 54° C.

TABLE 5
Stability features associated with the composition developed according to the
present invention were studied. The results are represented in the below table.

| | | | | | Initial | | 2 Weeks | | 1 Month | | 6 Months | |
|---|---|---|---|---|---|---|---|---|---|---|---|---|
| | | | | | Temp(° C.) | | | | | | | |
| Parameters | | | Specification | | N/A | | 54° C. | | 50° C. | | 25° C. | |
| Syneresis (%) (v/v) | | | N/A | | 0 | | 0 | | 0 | | 0 | |
| Sediment (Y/N) | | | N/A | | N | | N | | N | | N | |
| Water hardness, WHO SHW | | | 342 | ppm | 342 | ppm | 342 | ppm | 342 | ppm | 342 | ppm |
| Dilution Stability, | Initial | | N/A | | 0 | | 0 | | 0 | | 0 | |
| EM6018*, 2% (v/v) | 30 | min | ≤0.1 | mL S | <0.05 | (s) | <0.05 | (s) | <0.05 | (s) | <0.05 | (s) |
| Dilution (mL) | 1 | Hour | ≤0.1 | mL S | <0.05 | (s) | <0.05 | (s) | <0.05 | (s) | <0.05 | (s) |

| 2 | Hours | N/A | <0.05 | (s) | <0.05 | (s) | <0.05 | (s) | <0.05 | (s) |
|---|---|---|---|---|---|---|---|---|---|---|
| 4 | Hours | N/A | 0.05 | (s) | 0.05 | (s) | 0.05 | (s) | 0.05 | (s) |
| 24 | Hours | N/A | 0.30 | (s) | 0.20 | (s) | 0.5 | (s) | 0.30 | (s) |
| Reconstitute | | N/A | 0.20 (s) | | >50 0.15 (s) | | >50, 0.1 (s) | | 0.15 (s) @10 | |
| | | | 10inv & | | | | | | 0.10@50inv | |
| | | | 0.10 (s) | | | | | | | |
| | | | 50inv | | | | | | | |
| +30 | min | N/A | 0.15 | (s) | 0.15 | (s) | 0.10 | (s) | 0.15 | (s) |

| spontaneity of dispersion | 2% (v/v), at | | 60-105% | 88% | 97% | 96% | 98% |
|---|---|---|---|---|---|---|---|
| (CIPAC MT 160), | 30 C. | | | | | | |
| Gravimetricly | | | | | | | |
| Suspensibility. (CIPAC MT | 2% (v/v), at | | 60-105% | 96% | 96% | 96% | 100% |
| 184), Gravimetricly | 30 C. | | | | | | |
| pH (neat) (MT 75.3) | | | 3.5-4.5 | 4 | 4.1 | 3.9 | 4.3 |
| Viscosity at 20° C., | 2 min@6 rpm | | 300-600 | 595.19 | 588 | 550 | 564 |
| (cP), CP52 Spindle | | | | | | | |
| | 2 min@60 rpm | | 60-140 | 119.04 | 121 | 115 | 112 |
| Particle Size | d(0.1) | μm | N/A | 0.9 | 0.8 | 0.9 | 0.9 |
| | d(0.5) | μm | N/A | 2 | 2.0 | 2.1 | 2.0 |
| | d(0.9) | μm | <7 | 5 | 5.3 | 5.5 | 5.0 |

| | Span | N/A | | 2.107 | | 2.217 | | 2.129 | | 2.131 | |
|---|---|---|---|---|---|---|---|---|---|---|---|
| Persistent Foam, Water | 2% (v/v), 1 | <30 | mL | 4 | ml | 20 | ml | 20 | ml | 6 | ml |

| 342 ppm at RT (MT 75.3) | min | | | | | | | | | |
|---|---|---|---|---|---|---|---|---|---|---|
| | 2% (v/v), 12 | N/A | 0 | ml | <2 | ml | 8 | ml | <2 | ml |

| | | | | | | |
|---|---|---|---|---|---|---|
| | min | | | | | |
| Wet Sieve 75 μm (%), in Tap | | <2% | 0.07% | 0.03% | 0.09% | 0.04% |
| water | | | | | | |
| Pourability (MT 148), | | <5% | 4.92% | 3.70% | ND | 5.40% |
| 100 mL sample, =>Poured | | | | | | |
| Residue | | | | | | |
| Microscopic appearance, | | N/A | Well dispersed, | Well | ND | well dispersed |
| diluted in DI water | | | crystals mostly, | dispersed, | | crystals mostly <5 |
| | | | 5 um, upto 20 um, | crystals | | um, crystals seen |
| | | | no flocculation/ | under 30 um | | up to 15 um. No |
| | | | aggregation seen. | | | flocs/agglomerates |
| | | | | | | seen |

ND—Not Determined, N/A: Not Applicable, WHO SHW: World Health Organization Standard Hard Water.
The first column above refers to the test methods used to measure the different parameters of the stability

The compositions prepared according to the present invention remain stable according to the tested physico-chemical parameters. The stable agrochemical compositions demonstrated excellent suspensibility and dispersibility upon dilution. The active ingredients found to remain quite stable after preparation and even during storage studies.

1. A suspension concentrate formulation comprising:
(a) a tetramic acid derivative insecticide,
(b) one or more dispersing agents comprising a non-ionic copolymer and an anionic dispersant, and
(c) agriculturally acceptable excipients,
wherein the non-ionic copolymer and anionic dispersant are in a ratio ranging from 1:10 to 10:1.

2. The formulation as claimed in claim 1, wherein the tetramic acid derivative insecticide comprises spirotetramat spidoxamat or spiropidion.

3. The formulation as claimed in claim 1, wherein the non-ionic copolymer and the anionic dispersant are in a ratio ranging from 1:5 to 15:1.

4. The formulation as claimed in claim 1, wherein the non-ionic copolymer comprises a polymethyl methacrylate-polyethylene glycol graft copolymer.

5. The formulation as claimed in claim 1, wherein the anionic dispersant is an alkali salt of naphthalene sulfonate condensate.

6. The formulation as claimed in claim 1, wherein the anionic dispersant is a sodium salt of naphthalene sulfonate condensate.

7. The formulation as claimed in claim 1, wherein the tetramic acid derivative insecticide is in a concentration ranging from 30% w/v to 60% w/v.

8. The formulation as claimed in claim 1, wherein the non-ionic copolymer is in a concentration ranging from 1% w/v to 10% w/v.

9. The formulation as claimed in claim 1, wherein the anionic dispersant is in a concentration ranging from 1% w/v to 10% w/v.

10. The formulation as claimed in claim 1, wherein the agriculturally acceptable excipients are selected from pH modifiers, thickeners, preservatives, biocides, antifoam agents, anti-freeze agents, and solvent/carriers.

11. The formulation as claimed in claim 1, the formulation comprising;
(a) ≥300 g/L of spirotetramat,
(b) a polymethyl methacrylate-polyethylene glycol graft copolymer,
(c) a sodium salt of naphthalene sulfonate condensate, and
(d) the agriculturally acceptable excipients,
wherein the polymethyl methacrylate-polyethylene glycol graft copolymer and the sodium salt of a naphthalene sulfonate condensate is in a ratio ranging from 1:10 to 10:1.

12. The formulation as claimed in claim 11, wherein spirotetramat is in a concentration ranging from 300 g/L to 600 g/L.

13. A process for preparing a suspension concentrate formulation comprising ≥300 g/L of a tetramic acid derivative insecticide, the process comprising:
(a) mixing the tetramic acid derivative insecticide with a non-ionic copolymer and an anionic dispersant to obtain a homogenous blend,
(b) milling the homogeneous blend of step (a) to achieve a mill base having a D (90) particle size ranging from 0.1 to 10 μm,
(c) preparing a thickener mix, and
(d) mixing the milled tetramic acid insecticide blend, the thickener mix, and excipients to produce the suspension concentrate formulation;
wherein the non-ionic copolymer and the anionic dispersant are in a ratio ranging from 1:10 to 10:1.

14. The process as claimed in claim 13, the process comprising:
(a) mixing spirotetramat with a polymethyl methacrylate-polyethylene glycol graft copolymer and a sodium salt of naphthalene sulfonate condensate to obtain the homogenous blend,
(b) milling the blend of step (a) to achieve the mill base having a D (90) particle size ranging from 0.1 to 10 μm,
(c) preparing the thickener mix, and
(d) mixing the spirotetramat blend, the thickener mix, and excipients to produce the suspension concentrate formulation;
wherein the polymethyl methacrylate-polyethylene glycol graft copolymer and the sodium salt of naphthalene sulfonate condensate are in a ratio ranging from 1:10 to 10:1.

15. A method of controlling insect infestation in crops, comprising applying a suspension concentrate formulation comprising ≥300 g/L of a tetramic acid derivative insecticide to the crops or their locus.
